(19) United States
(12) Patent Application Publication
(10) Pub. No.: US 2012/0062873 A1
(43) Pub. Date: Mar. 15, 2012

(54) SYSTEM AND METHOD FOR DIAGNOSING THE DISEASE STATE OF BREAST TISSUE USING SWIR

(75) Inventors: Shona Stewart, Pittsburgh, PA (US); John Maier, Pittsburgh, PA (US); Jeffrey Cohen, Pittsburgh, PA (US)

(73) Assignee: Chemimage Corporation, Pittsburgh, PA (US)

(21) Appl. No.: 13/153,775

(22) Filed: Jun. 6, 2011

Related U.S. Application Data
(63) Continuation-in-part of application No. 12/206,500, filed on Sep. 8, 2008, now Pat. No. 7,956,996.
Application No. 12/206,500 is a continuation-in-part of application No. 12/070,010, filed on Feb. 14, 2008, now Pat. No. 7,808,633.
Application No. 12/070,010 is a continuation-in-part of application No. 11/204,196, filed on Aug. 9, 2005.
Application No. 11/204,196 is a continuation of application No. 10/184,580, filed on Jun. 28, 2002, now Pat. No. 6,965,793.
Application No. 10/184,580 is a continuation-in-part of application No. 12/834,370, filed on Jul. 12, 2010, now Pat. No. 7,990,533.
Application No. 12/834,370 is a continuation of application No. 12/206,467, filed on Sep. 8, 2008, now Pat. No. 7,755,757.
Application No. 12/206,467 is a continuation-in-part of application No. 12/070,010, filed on Feb. 14, 2008, now Pat. No. 7,808,633.
(60) Provisional application No. 60/971,949, filed on Sep. 13, 2007.
(60) Provisional application No. 60/301,708, filed on Jun. 28, 2001.

(51) Int. Cl. G01N 21/00; G01J 3/44; G01N 21/64; G01J 5/08

(52) U.S. Cl. 356/72; 250/341.8; 356/301; 250/458.1

(57) ABSTRACT

A system and method to provide a diagnosis of the breast disease state of a test breast sample. A database containing a plurality of reference SWIR data sets is provided where each reference SWIR data set has an associated known breast sample and an associated known breast disease state. A test breast sample is irradiated with substantially monochromatic light to generate scattered photons resulting in a test SWIR data set. The test SWIR data set is compared to the plurality of reference SWIR data sets using a chemometric technique. Based on the comparison, a diagnosis of a breast disease state of the test breast sample is provided. The breast disease state includes invasive ductal carcinoma or invasive lobular carcinoma disease state.

### RELATED APPLICATIONS

This application is a continuation-in-part of pending U.S. patent application Ser. No. 12/206,500, filed on Sep. 8, 2008, entitled “Distinguishing Between Invasive Ductal Carcinoma And Invasive Lobular Carcinoma Using Raman Molecular Imaging,” which is a continuation-in-part of U.S. patent application Ser. No. 12/070,010, now U.S. Pat. No. 7,808,633, filed on Feb. 14, 2008, entitled “Spectroscopic System And Method For Predicting Outcome Of Disease,” and claims priority under 35 U.S.C. §119(e) to U.S. Provisional Patent Application No. 60/971,949, filed on Sep. 13, 2007, entitled “Distinguishing Between Invasive Ductal Carcinoma and Invasive Lobular Carcinoma Using Raman Molecular Imaging.”

This application is also a continuation-in-part of pending. U.S. patent application Ser. No. 11/204,196, filed on Aug. 9, 2005, entitled “Raman Chemical Imaging of Breast Tissue,” which itself is a continuation of U.S. Pat. No. 6,965,793, filed on Jun. 28, 2002, entitled “Method For Raman Chemical Imaging Of Endogenous Chemicals To Reveal Tissue Lesion Boundaries In Tissue” a continuation of U.S. Pat. No. 6,954,667, filed on Jun. 27, 2002, entitled “Method For Raman Chemical Imaging And Characterization Of Calcification In Tissue”, and claims priority under 35 U.S.C. §119(e) to U.S. Provisional Patent Application No. 60/301,708, filed on Jun. 28, 2001, entitled “Method For Objective Evaluation Of Tissue Using Raman Imaging Spectroscopy”.

This application is also a continuation-in-part of pending U.S. patent application Ser. No. 12/834,370, filed on Jul. 12, 2010, entitled “System and Method for Analyzing Biological Samples Using Raman Molecular Imaging,” which itself is a continuation of U.S. Pat. No. 7,755,757, filed on Sep. 8, 2008, entitled “Distinguishing Between Renal Oncocytoma And Chromophobe Renal Cell Carcinoma Using Raman Molecular Imaging” and a continuation-in-part of U.S. Pat. No. 7,808,633, filed on Feb. 14, 2008, entitled “Spectroscopic System And Method For Predicting Outcome Of Disease.” These applications are hereby incorporated by reference in their entireties.

### BACKGROUND

The biochemical composition of a cell is a complex mix of biological molecules including, but not limited to, proteins, nucleic acids, lipids, and carbohydrates. The composition and interaction of the biological molecules determines the metabolic state of a cell. The metabolic state of the cell will dictate the type of cell and its function (i.e., red blood cell, epithelial cell, etc.). Tissue is generally understood to mean a group of cells that work together to perform a function. Spectroscopic techniques provide information about the biological molecules contained in cells and tissues and therefore provide information about the metabolic state. As the cell's or tissue's metabolic state changes from the normal state to a diseased state, spectroscopic techniques can provide information to indicate the metabolic change and therefore serve to diagnose and predict the outcome of a disease. Cancer is a prevalent disease, so physicians are very concerned with being able to accurately diagnose cancer and to determine the best course of treatment.

Spectroscopic imaging combines digital imaging and molecular spectroscopy techniques, which can include Raman scattering, fluorescence, photoluminescence, ultraviolet, visible and infrared absorption spectroscopies. When applied to the chemical analysis of materials, spectroscopic imaging is commonly referred to as chemical imaging. Instruments for performing spectroscopic (i.e. chemical) imaging typically comprise an illumination source, image gathering optics, focal plane array imaging detectors and imaging spectrometers.

In general, the sample size determines the choice of image gathering optic. For example, a microscope is typically employed for the analysis of sub micron to millimeter spatial dimension samples. For larger objects, in the range of millimeter to meter dimensions, macro lens optics are appropriate. For samples located within relatively inaccessible environments, flexible fiberscope or rigid borescopes can be employed. For very large scale objects, such as planetary objects, telescopes are appropriate image gathering optics.

For detection of images formed by the various optical systems, two-dimensional, imaging focal plane array (FPA) detectors are typically employed. The choice of FPA detector is governed by the spectroscopic technique employed to characterize the sample of interest. For example, silicon (Si) charge-coupled device (CCD) detectors or CMOS detectors are typically employed with visible wavelength fluorescence and Raman spectroscopic imaging systems, while indium gallium arsenide (InGaAs) FPA detectors are typically employed with near-infrared spectroscopic imaging systems.

Spectroscopic imaging of a sample can be implemented by one of two methods. First, a point-source illumination can be provided on the sample to measure the spectra at each point of the illuminated area. Second, spectra can be collected over the an entire area encompassing the sample simultaneously using an electronically tunable optical imaging filter such as an acousto-optic tunable filter (AOTF), a multi-conjugate tunable filter (MCF), or a liquid crystal tunable filter (LCTF). Here, the organic material in such optical filters are actively aligned by applied voltages to produce the desired bandpass and transmission function. The spectra obtained for each pixel of such an image thereby forms a complex data set referred to as a hyperspectral image which contains the intensity values at numerous wavelengths or the wavelength dependence of each pixel element in this image.

The ability to determine a disease state is critical to histological analysis. Such testing often requires obtaining the spectrum of a sample at different wavelengths. Conventional spectroscopic devices operate over a limited range of wavelengths due to the operation ranges of the detectors or tunable filters possible. This enables analysis in the Ultraviolet (UV), visible (VIS), near infrared (NIR), short wave infrared (SWIR) mid infrared (MIR) wavelengths and to some overlapping ranges. These correspond to wavelengths of about 180-380 nm (UV), 380-700 nm (VIS), 700-2500 nm (NIR), 850-1700 nm (SWIR) and 2500-25000 nm (MIR).

Thus, to obtain a comprehensive analysis over a broad range of wavelengths (i.e., a hyperspectral image) more than one spectroscopic device must be applied. Such broad or extended ranges make application time-consuming and not often possible. The sample position and condition may be changed between the first analysis or a later analysis thereby lessening the ability to precisely correlate the spectra obtained at different wavelength ranges. There is a need for rapid, non-invasive instrument capable of operating at IR, NIR, SWIR, visible, fluorescence, luminescence and Raman modes to provide hyperspectral imaging of a sample.

Various types of spectroscopy and imaging may be explored for detection of various types of diseases in particular cancers. Raman spectroscopy is based on irradiation of a sample and detection of scattered radiation, and it can be employed non-invasively to analyze biological samples in situ. Thus, little or no sample preparation is required. Raman spectroscopy techniques can be readily performed in aqueous environments because water exhibits very little, but predictable, Raman scattering. It is particularly amenable to in vivo measurements as the powers and excitation wavelengths used are non-destructive to the tissue and have a relatively large penetration depth.

Raman chemical imaging (RCI) is a reagentless tissue imaging approach based on the scattering of laser light from tissue samples. The approach yields an image of a sample wherein each pixel of the image is the Raman spectrum of the sample at the corresponding location. The Raman spectrum carries information about the local chemical environment of the sample at each location. RCI has a spatial resolving power of approximately 250 nm and can potentially provide qualitative and quantitative image information based on molecular composition and morphology.

The vast majority of diseases, in particular cancer cases, are pathologically diagnosed using tissue from a biopsy specimen. An experienced pathologist can provide diagnostic information used to make management decisions for the treatment of the cancer. Invasive Ductal and Invasive Lobular breast carcinomas are the common histological types of breast cancer, and distinguishing between them can at times present a problem to pathologists inspecting histopathological features of a tissue. Although clinical data and metastatic patterns indicate that development and progression of these tumors are different, these tumors are often similar in appearance and not distinguishable by histopathological examination only. E-cadherin is a stain which has had some success in distinguishing between the two tumors.

Therefore it is desirable to devise methodologies that use spectroscopic techniques to differentiate various cell types (e.g., normal, malignant, benign, etc.), to classify biological samples under investigation (e.g., a normal tissue, a diseased tissue, invasive ductal carcinoma disease state and invasive lobular carcinoma disease state), and to also predict clinical outcome (e.g., progressive or non-progressive state of cancer, etc.) of a diseased cell or tissue.

### SUMMARY

The present disclosure relates generally to spectroscopic methods for diagnosing tissue samples. More specifically, the present disclosure relates to a system and method for diagnosing breast tissue samples using SWIR hyperspectral imaging. The present disclosure also provides for the fusion of two or more types of spectroscopic information. This fusion may combine SWIR, Raman and/or fluorescence spectroscopic data to provide more robust results.

The system and methods described herein can potentially be utilized by a decision maker, such as a pathologist, to diagnose a breast tissue sample as characteristic of a particular disease state. The invention of the present disclosure also holds potential for cases where existing lesions have overlapping histopathologic features of different types of cancer, for example invasive ductal carcinoma and invasive lobular carcinoma. Because these diseases have different prognoses and treatments, correctly identifying them has major implications for the health of patients.

### BRIEF DESCRIPTION OF THE DRAWINGS

The accompanying drawings, which are included to provide further understanding of the disclosure and are incorporated in and constitute a part of this specification, illustrate embodiments of the disclosure and, together with the description, serve to explain the principles of the disclosure.

In the drawings:

FIG. 1 schematically represents an exemplary system of the present disclosure;

FIG. 2A schematically represents an exemplary spectroscopy module of the present disclosure;

FIG. 2B schematically represents an exemplary system of the present disclosure;

FIG. 2C schematically represents an exemplary system of the present disclosure;

FIG. 3 is illustrative of a method of the present disclosure.

FIG. 4 is illustrative of a method of the present disclosure.

### DETAILED DESCRIPTION OF THE DISCLOSURE

Reference will now be made in detail to the preferred embodiments of the present disclosure, examples of which are illustrated in the accompanying drawings. Wherever possible, the same reference numbers will be used throughout the drawings to refer to the same or like parts.

Spectroscopy and/or hyperspectral imaging holds potential for differentiating normal vs. malignant tissue and differentiating normal vs. benign tissue. The present disclosure provides for a system and method for analyzing breast tissue samples using spectroscopy and/or hyperspectral imaging. In one embodiment, the present disclosure may utilize SWIR spectroscopic methods, which may include SWIR hyperspectral imaging.

The system and methods described herein can potentially be utilized by a decision maker, such as pathologist, to identify a type of breast cancer in cases where existing lesions have overlapping histopathologic features. In one embodiment, the system and method described herein may be used to identify the presence of at least one of: invasive ductal carcinoma and invasive lobular carcinoma. Because these diseases have different prognoses and treatments, correctly identifying them may have major implications for the health of patients.

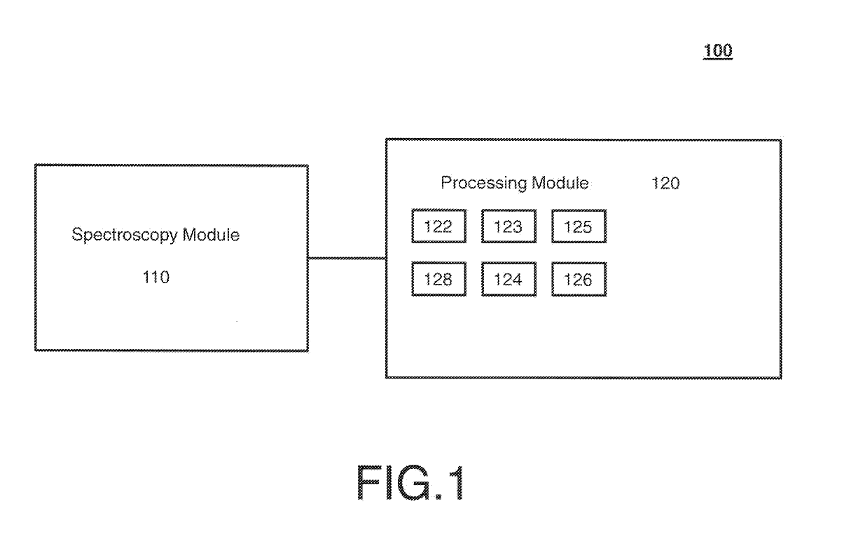

FIG. 1 illustrates an exemplary system 100 according to one embodiment of the present disclosure. System 100 includes a spectroscopy module 110 in communication with a processing module 120. Processing module 120 may include a processor 122, databases 123, 124, 125 and 126, and machine readable program code 128. The machine readable program code 128 may contain executable program instructions, and the processor 122 may be configured to execute the machine readable program code 128 so as to perform the methods of the present disclosure. In one embodiment, the program code 128 may contain the ChemImage Xpert™ software marketed by ChemImage Corporation of Pittsburgh, Pa. The Xpert™ software may be used to process spectroscopic data and information received from the spectroscopy module 110 to obtain various spectral plots and images, and to also carry out various multivariate image analysis methods discussed later herein below.

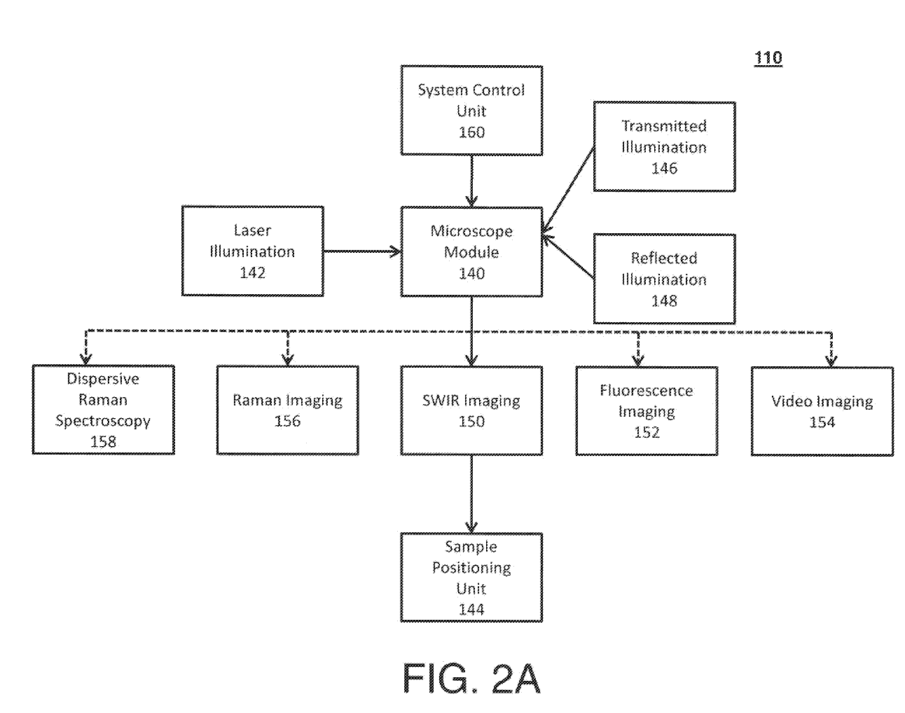

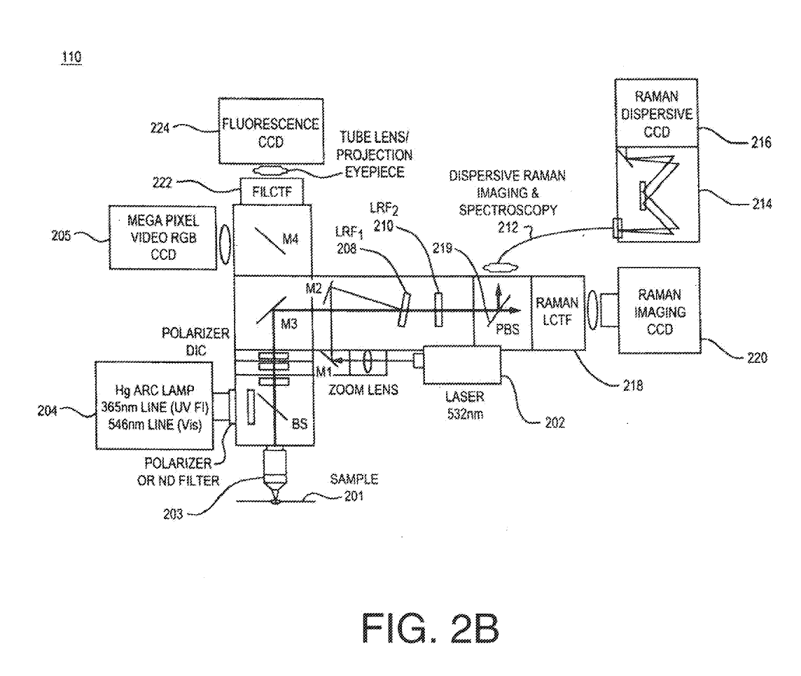

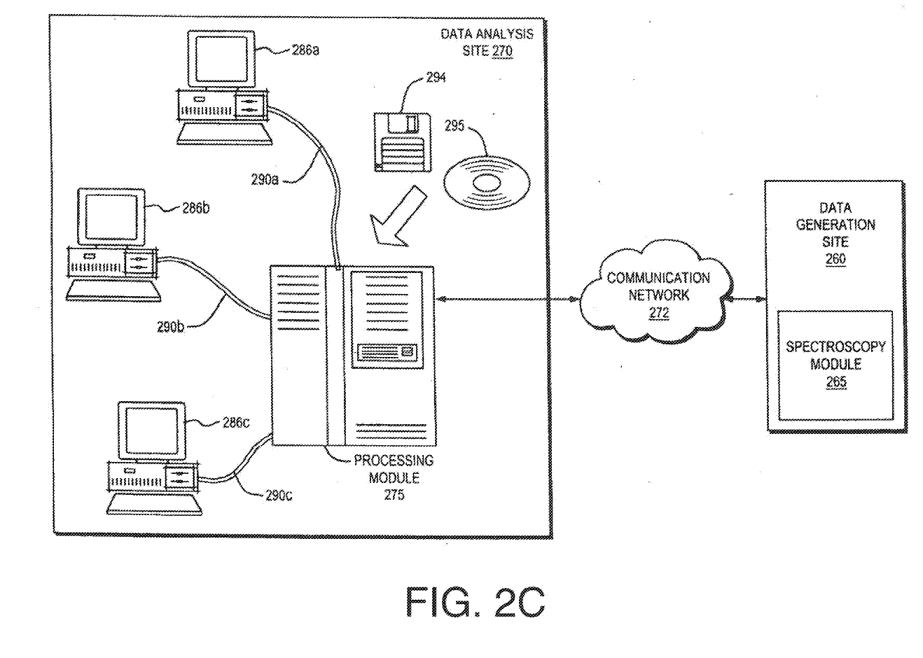

FIG. 2A illustrates an exemplary schematic layout of the spectroscopy module 110 shown in FIG. 1. The layout in FIG. 2A may relate to a chemical imaging system marketed by ChemImage Corporation of Pittsburgh, Pa. In one embodiment, the spectroscopy module 110 may include a microscope module 140 containing optics for microscope applications. An illumination source 142 (e.g., a laser illumination source) may provide illuminating photons to a sample (not shown) handled by a sample positioning unit 144 via the microscope module 140. In one embodiment, photons transmitted, reflected, emitted, absorbed, or scattered from the illuminated sample (not shown) may pass through the microscope module (as illustrated by exemplary blocks 146, 148 in FIG. 2A) before being directed to one or more of spectroscopy or imaging optics in the spectroscopy module 110. In the embodiment of FIG. 2A, SWIR imaging 150 is illustrated as a “standard” operational mode of the spectroscopy module 110. Optional imaging modes, indicated in FIG. 2A with a dashed line, may comprise at least one of: dispersive Raman spectroscopy 158, Raman imaging 156, fluorescence imaging 152, video imaging 154, and combinations thereof. The spectroscopy module 110 may also include a system control unit 160 to control operational aspects (e.g., focusing, sample placement, laser beam transmission, etc.) of various system components including, for example, the microscope module 140 and the sample positioning unit 144 as illustrated in FIG. 2A. In one embodiment, operation of various components (including the control unit 160) in the spectroscopy module 110 may be fully automated or partially automated, under user control.

It is noted here that in the discussion herein the terms “illumination,” “illuminating,” “irradiation,” and “excitation” are used interchangeably as can be evident from the context. For example, the terms “illumination source,” “light source,” and “excitation source” are used interchangeably. Similarly, the terms “illuminating photons” and “excitation photons” are also used interchangeably. Furthermore, although the discussion hereinbelow focuses more on SWIR spectroscopy and SWIR hyperspectral imaging, various methodologies discussed herein may be adapted to be used in conjunction with other types of spectroscopy applications as can be evident to one skilled in the art based on the discussion provided herein.

Spectroscopy module 110 may operate in several experimental modes of operation including bright field reflectance and transmission imaging, polarized light imaging, differential interference contrast (DIC) imaging, UV induced autofluorescence imaging, SWIR imaging, near infrared imaging, infrared imaging, Raman imaging, fluorescence imaging, and combinations thereof. These modes of operation may implement wide field imaging.

One embodiment of the present disclosure is illustrated in FIG. 2B. In such an embodiment, sample 201 may include a variety of biological samples. In one embodiment, the sample 201 includes at least one cell or a tissue containing a plurality of cells. The sample may contain normal (non-diseased or benign) cells, diseased cells (e.g., cancerous tissues with or without a progressive cancer state or malignant cells with or without a progressive cancer state) or a combination of normal and diseased cells. In one embodiment, the cell/tissue is a mammalian cell/tissue. Some examples of biological samples may include prostate cells, breast cells, kidney cells, lung cells, colon cells, bone marrow cells, brain cells, red blood cells, and cardiac muscle cells. In one embodiment, the biological sample may include prostate cells. In one such embodiment, the biological sample may include Gleason 6 prostate cells. In another such embodiment, the biological sample may include Gleason 7 prostate cells. In another embodiment the biological sample 201 may include a breast sample. In one such embodiment, the biological sample 201 may include an invasive ductal carcinoma sample. In another such embodiment, the biological sample 201 may include an invasive lobular carcinoma. In another embodiment, the sample 201 may include cells of plants, non-mammalian animals, fingi, protists, and monera.

In yet another embodiment, the sample 201 may include a test sample (e.g., a biological sample under test to determine its metabolic state or its disease status or to determine whether it is cancerous state would progress to the next level). The “test sample,” “target sample,” “test breast sample” or “unknown sample” are used interchangeably herein to refer to a biological sample or breast sample under investigation, wherein such interchange use may be without reference to such biological sample's metabolic state or disease status or disease state.

A progressive cancer state is a cancer that will go on to become aggressive and acquire subsequent treatment by more aggressive means in order for the patient to survive. An example of progressive cancer is a Gleason score 7 cancer found in a prostate which has been surgically removed, where the patient, subsequent to the removal of the prostate, develops metastatic cancer. In this example the cancer progressed even after the removal of the source organ. Progressive cancers can be detected and identified in other organs and different types of cancer.

A non-progressive cancer is a cancer that does not progress to more advanced disease, requiring aggressive treatment. Many prostate cancers are non-progressive by this definition because though they are cancer by standard histopathological definition, they do not impact the life of the patient in a way that requires significant treatment. In many cases such cancers are observed and treated only if they show evidence of becoming progressive. Again, this is not a state particular to prostate cancer. Cancer cells are present in tissues of many healthy people. Because these do not ever transition to a state where they become progressive in terms of growth, danger to the patient, or inconvenience to the patient they would be considered non-progressive as the term is used herein.

The designation of progressive vs. non progressive can also be extended to other disease or metabolic states. As an example, diabetes can be clinically described as “stable”, “well managed” by a clinician and would fall into the non-progressive class. In contrast diabetes can be progressing through the common course of the disease with all of the effects on kidneys, skin, nerves, heart and other organs which are part of the disease. As a second example multiple sclerosis is a disease which exists in many people is a stable, non-progressive state. In some people the disease rapidly progresses through historically observed pattern of physical characteristics with clinical manifestations.

The cells can be isolated cells, such as individual blood cells or cells of a solid tissue that have been separated from other cells of the tissue (e.g., by degradation of the intracellular matrix). The cells can also be cells present in a mass, such as a bacterial colony grown on a semi-solid medium or an intact or physically disrupted tissue. By way of example, blood drawn from a human can be smeared on the surface of a suitable substrate (e.g., an aluminum-coated glass slide) and individual cells in the sample can be separately imaged by light microscopy and SWIR analysis using the spectroscopy module 110 of FIG. 2A. Similarly a slice of a solid tissue (e.g., a piece of fresh tissue or a paraffin-embedded thin section of a tissue) can be imaged on a suitable surface.

The cells can be cells obtained from a subject (e.g., cells obtained from a human blood or urine sample, semen sample, tissue biopsy, or surgical procedure). Cells can also be studied where they naturally occur, such as cells in an accessible location (e.g., a location on or within a human body), cells in a remote location using a suitable probe, or by revealing cells (e.g., surgically) that are not normally accessible.

FIG. 2B illustrates exemplary details of the spectroscopy module 110 in FIG. 2A according to one embodiment of the present disclosure. Spectroscopy module 110 may operate in several experimental modes of operation including bright field reflectance and transmission imaging, polarized light imaging, differential interference contrast (DIC) imaging, UV induced autofluorescence imaging, NIR imaging, SWIR imaging, Raman spectroscopy, fluorescence imaging, and Raman imaging.

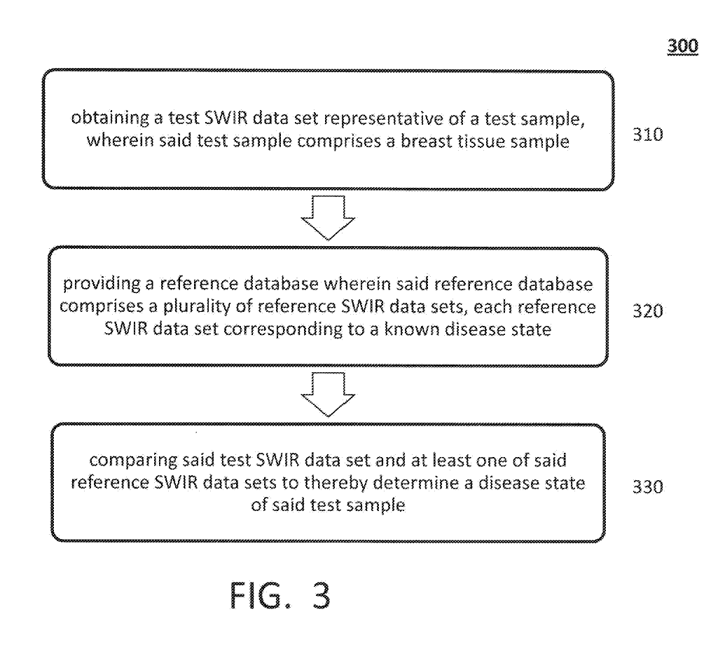

FIG. 2B is illustrative of an embodiment of the present disclosure operating in a Raman and florescence mode. Module 110 may include collection optics 203, light sources 202 and 204, and a plurality of spectral information processing devices including, for example: a tunable fluorescence filter 222, a tunable Raman filter 218, a dispersive spectrometer 214, a plurality of detectors including a fluorescence detector 224, and Raman detectors 216 and 220, a fiber array spectral translator (“FAST”) device 212, filters 208 and 210 and a polarized beam splitter (PBS) 219. In one embodiment, the processor 122 (FIG. 1) may be operatively coupled to light sources 202 and 204, and the plurality of spectral information processing devices 214, 218 and 222. In another embodiment, the processor 122 (FIG. 1), when suitably programmed, can configure various functional parts of the spectroscopy module in FIG. 1 and may also control their operation at run time. The processor, when suitably programmed, may also facilitate various remote data transfer and analysis operations discussed in conjunction with FIG. 3. Module 110 may optionally include a video camera 205 for video imaging applications. Although not shown in FIG. 2B, spectroscopy module 110 may include many additional optical and electrical components to carry out various spectroscopy and imaging applications supported thereby.

In one embodiment, the system of FIG. 2B may be configured so as to further operate in a SWIR modality. In such an embodiment, the system may further comprise additional features such as a SWIR tunable filter, a SWIR detector, and additional beam splitters to aid in data generation. In one embodiment, this SWIR detector may comprise a focal plane array detector. In one embodiment, the SWIR detector may comprise a InGaAs detector.

A sample 201 may be placed at a focusing location (e.g., by using the sample positioning unit 144 in FIG. 2A) to receive illuminating photons and to also provide reflected, absorbed, emitted, scattered, or transmitted photons from the sample 201 to the collection optics 203. Sample 201 may include a variety of biological samples. In one embodiment, the sample 201 includes at least one cell or a tissue containing a plurality of cells.

Referring again to FIG. 2B, light source 202 may be used to irradiate the sample 201. Light source 202 can include any conventional photon source, including, for example, a laser, an LED (light emitting diode), or other IR (infrared) or SWIR devices. When operating in a Raman modality, this illuminating light may comprise substantially monochromatic light.

The light reaching the sample 201 illuminates the sample 201, and may produce interacted photons. These photons may comprise at least one of photons reflected, absorbed, emitted, transmitted, and scattered from different locations on or within the illuminated sample 201. A portion of the interacted photons from the sample 201 may be collected by the collection optics 203 and directed to various system components for analysis. In one embodiment, the interacted photons may be directed to a SWIR tunable filter and a SWIR detector for SWIR analysis.

In another embodiment, interacted photons may be directed to a dispersive spectrometer 214 or Raman tunable filter 218 for further processing discussed later herein below. In one embodiment, light source 202 includes a laser light source producing light at 532.1 nm.

The laser excitation signal may be focused on the sample 201 through combined operation of reflecting mirrors M1, M2, M3, the filter 208, and the collection optics 203 as illustrated by an exemplary optical path in the embodiment of FIG. 2B. The filter 208 may be tilted at a specific angle from the vertical (e.g., at 6.5.sup.0) to reflect laser illumination onto the mirror M3, but not to reflect Raman-scattered photons received from the sample 201. The other filter 210 may not be tilted (i.e., it remains at 0.degree. from the vertical). Filters 208 and 210 may function as laser line rejection filters to reject light at the wavelength of laser light source 202.

In the spectroscopy module 110 in the embodiment of FIG. 2B, the second light source 204 may be used to irradiate the sample 201 with ultraviolet light or visible light. In one embodiment, the light source 204 includes a mercury arc (Hg arc) lamp that produces ultraviolet radiation (UV) having wavelength at 365 nm for fluorescence spectroscopy applications. In yet another embodiment, the light source 204 may produce visible light at 546 nm for visible light imaging applications. A polarizer or neutral density (ND) filter with or without a beam splitter (BS) may be provided in front of the light source 204 to obtain desired illumination light intensity and polarization.

In one embodiment, a system of the present disclosure is configured so as to generate a test SWIR data set representative of a test sample. A test SWIR data set may correspond to one or more of the following: a plurality of SWIR spectra representative of the sample, a plurality of spatially accurate wavelength resolved SWIR images representative of the sample, and combinations thereof. In one embodiment, a test SWIR data set may correspond to a SWIR hyperspectral image representative of the sample.

In such an embodiment, the SWIR data set corresponds to a three dimensional block of SWIR data (e.g., a spectral hypercube or a SWIR image) having spatial dimensional data represented in the x and y dimensions and wavelength data represented in the z dimension. Each SWIR image has a plurality of pixels where each has a corresponding x and y position in the SWIR image. The SWIR image may have one or more regions of interest. The regions of interest may be identified by the size and shape of one or more pixels and is selected where the pixels are located within the regions of interest. A single SWIR spectrum is then extracted from each pixel located in the region of interest, leading to a plurality of SWIR spectra for each of the regions of interest. The extracted plurality of SWIR spectra are then designated as the SWIR data set. In this embodiment, the plurality of SWIR spectra and the plurality of spatially accurate wavelength resolved SWIR images are generated, as components of the hypercube, by a combination of a SWIR tunable filter and SWIR imaging detector or by a combination of a FAST device, a spectrometer, and a SWIR detector.

In yet another embodiment, a SWIR dataset is generated using a SWIR image to identify one or more regions of interest of the sample 201. In one such embodiment, the one or more regions of interest contain at least one of the following: an epithelium area, a stroma area, epithelial-stromal junction (ESS) area and/or nuclei area. A plurality of SWIR spectra may be obtained from the one or more of regions of interest of the sample 201. In standard operation the SWIR spectrum generated by selecting a region of interest in a SWIR image is the average spectrum of all the spectra at each pixel within the region of interest. The standard deviation between of all the spectra in the region of interest may be displayed along with the average SWIR spectrum of the region of interest. Alternatively, all of the spectra associated with pixels within a region can be considered as a plurality of spectra, without the step of reducing them to a mean and standard deviation.

In the embodiment of FIG. 2B, the dispersive spectrometer 214 and the Raman tunable filter 218 may function to produce Raman data sets of sample 201. A Raman data set corresponds to one or more of the following: a plurality of Raman spectra of the sample; and a plurality of spatially accurate wavelength resolved Raman images of the sample. In one embodiment, the plurality of Raman spectra is generated by dispersive spectral measurements of individual cells. In this embodiment, the illumination of the individual cell may cover the entire area of the cell so the dispersive Raman spectrum is an integrated measure of spectral response from all the locations within the cell.

With further reference to FIG. 2B, the fluorescence tunable filter 222 may function to produce fluorescence data sets of the photons emitted from the sample 201 under suitable illumination (e.g., UV illumination). In one embodiment, the fluorescence data set includes a plurality of fluorescence spectra of sample 201 anchor a plurality of spatially accurate wavelength resolved fluorescence images of sample 201. A fluorescence spectrum of sample 210 may contain a fluorescence emission signature of the sample 201. In one embodiment, the emission signature may be indicative of a fluorescent probe (e.g., fluorescein isothiocyanate) within the sample 201. The fluorescence data sets may be detected by fluorescence CCD detector 224. A portion of the fluorescence emitted photons or visible light reflected photons from the sample 201 may be directed to the video imaging camera 205 via a mirror M4 and appropriate optical signal focusing mechanism.

In one embodiment, a microscope objective (including the collection optics 203) may be automatically or manually zoomed in or out to obtain proper focusing of the sample.

The entrance slit (not shown) of the spectrometer 214 may be optically coupled to the output end of the fiber array spectral translator device 212 to disperse the Raman scattered photons received from the FAST device 212 and to generate a plurality of spatially resolved Raman spectra from the wavelength-dispersed photons. The FAST device 212 may receive Raman scattered photons from the beam splitter 219, which may split and appropriately polarize the Raman scattered photons received from the sample 201 and transmit corresponding portions to the input end of the FAST device 212 and the input end of the Raman tunable filter 218.

Referring again to FIG. 2B, the tunable fluorescence filter 222 and the tunable Raman filter 218 may be used to individually tune specific photon wavelengths of interest and to thereby generate a plurality of spatially accurate wavelength resolved spectroscopic fluorescence images and Raman images, respectively, in conjunction with corresponding detectors 224 and 220. In one embodiment, each of the fluorescence filter 222 and the Raman filter 218 includes a two-dimensional tunable filter, such as, for example, an electro-optical tunable filter, a liquid crystal tunable filter (LCTF), or an acousto-optical tunable filter (AOTF). A tunable filter may be a band-pass or narrow band filter that can sequentially pass or “tune” fluorescence emitted photons or Raman scattered photons into a plurality of predetermined wavelength hands. The plurality of predetermined wavelength bands may include specific wavelengths or ranges of wavelengths. In one embodiment, the predetermined wavelength bands may include wavelengths characteristic of the sample undergoing analysis. The wavelengths that can be passed through the fluorescence filter 222 and Raman filter 218 may range from 200 nm. (ultraviolet) to 2000 nm (i.e., the far infrared). The choice of a tunable filter depends on the desired optical region and/or the nature of the sample being analyzed. Additional examples of a two-dimensional tunable filter may include a Fabry Perot angle tuned filter, a Lyot filter, an Evans split element liquid crystal tunable filter, a Sole liquid crystal tunable filter, a spectral diversity filter, a photonic crystal filter, a fixed wavelength Fabry Perot tunable filter, an air-tuned Fabry Perot tunable filter, a mechanically-tuned Fabry Perot tunable filter, and a liquid crystal Fabry Perot tunable filter. As noted before, the tunable filters 218, 222 may be selected to operate in one or more of the following spectral ranges: the ultraviolet (UV), visible, and near infrared. In one such embodiment, the tunable filters 218, 222 may be selected to operate in spectra ranges of 900-1155 cm.sup.-1 and 15-30-1850 cm.sup.-1 Raman shift values.

In one embodiment, a multi-conjugate filter (MCF) may be used instead of a simple LCTF (e.g., the LCTF 218 or 222) to provide more precise wavelength tuning of photons received from the sample 201. Some exemplary multi-conjugate filters are discussed, for example, in U.S. Pat. No. 6,992,809, titled “Multi-Conjugate Liquid Crystal Tunable Filter,” filed on Jan. 31, 2006; and U.S. Pat. No. 7,362,489, titled “Liquid Crystal Filter with Tunable Rejection Band,” filed on Apr. 22, 2008. The disclosures of both of these patents are incorporated herein by reference in their entireties.

In the embodiment of FIG. 2B, the fluorescence spectral data sets (output from the tunable filter 222) may be detected by the detector 224, and the Raman spectral data sets (output from the spectrometer 214 and the tunable filter 218) may be detected by detectors 216 and 220. The detectors 216, 220, and 224 may detect received photons in a spatially accurate manner. Detectors 216, 220 and 224 may include an optical signal (or photon) collection device such as, for example, an image focal plane array (FPA) detector, a charge coupled device (CC D) detector, or a CMOS (Complementary Metal Oxide Semiconductor) array sensor. Detectors 216, 220 and 224 may measure the intensity of scattered, transmitted or reflected light incident upon their sensing surfaces (not shown) at multiple discrete locations or pixels, and transfer the spectral information received to the processor module 120 for storage and analysis. The optical region employed to characterize the sample of interest governs the choice of two-dimensional array detector. For example, a two-dimensional array of silicon charge-coupled device (CCD) detection elements can be employed with visible wavelength emitted or reflected photons, or with Raman scatter photons, while gallium arsenide (GaAs) and gallium indium arsenide (GaTnAs) FPA detectors can be employed for image analyses at near infrared wavelengths. The choice of such devices may also depend on the type of sample being analyzed.

In one embodiment, a display unit (not shown) may be provided to display spectral data collected by various detectors 216, 220, 224 in a predefined or user-selected format. The display unit may be a computer display screen, a display monitor, an LCD (liquid crystal display) screen, or any other type of electronic display device.

Referring again to FIG. 1, the databases 123-126 may store various reference spectral data sets including, for example, a reference Raman data set, a reference fluorescence data set, a reference SWIR data set, a reference NIR data set, etc. The reference data sets may be collected from different samples and may be used to detect or identify the sample 201 from comparison of its spectral data set with the reference data sets. In one embodiment, during operation, the test data sets generated (SWIR, Raman, and/or fluorescence) of the sample 201 also may be stored in one or more of the databases (e.g., database 123) of the processing module 120.

For example, in one embodiment, database 123 may be used to store a plurality of reference SWIR data sets from reference cells having a known metabolic state or a known disease state. In one such embodiment, the reference SWIR data sets may correspond to a plurality of reference SWIR spectra. In another such embodiment, the reference SWIR data sets may correspond to a plurality of reference spatially accurate wavelength resolved SWIR images.

In another embodiment, the database 124 may be used to store a first plurality of reference SWIR data sets from reference normal (non-diseased) cells. In one embodiment, the first reference set of SWIR data sets may include a plurality of first reference SWIR spectra. In another embodiment, a first reference SWIR spectrum may correspond to a dispersive SWIR spectrum. In a further embodiment, the first reference set of SWIR data sets may include a plurality of first reference spatially accurate wavelength resolved SWIR images obtained from corresponding reference normal cells.

In another embodiment, the database 124 may be used to store a first plurality of reference SWIR data sets from first reference disease state cells. In one such embodiment, the first reference diseased state cells correspond to reference invasive ductal carcinoma cells. In one embodiment, the first reference set of SWIR data sets may include a plurality of first reference SWIR spectra. In another embodiment, a first reference SWIR spectrum may correspond to a dispersive SWIR spectrum. In a further embodiment, the first reference set of SWIR data sets may include a plurality of first reference spatially accurate wavelength resolved SWIR images obtained from corresponding reference first disease state cells.

In yet another embodiment, the database 125 may store a second plurality of reference SWIR data sets from different types of second reference disease state cells. In one such embodiment, the second reference disease state cells correspond to invasive lobular carcinoma cells. In one embodiment, the second reference set of SWIR data sets includes a plurality of second reference SWIR spectra. In one embodiment, the second reference SWIR spectrum may correspond to a dispersive SWIR spectrum. In another embodiment, the second reference set of SWIR data sets may include a plurality of second reference spatially accurate wavelength resolved SWIR images obtained from corresponding reference second disease state cells.

In another embodiment, the database 126 may store a plurality of reference Raman spectra and/or a plurality of spatially accurate wavelength resolved Raman images obtained from reference biological samples. Similarly, database 126 may store a plurality of reference fluorescence spectra and/or a plurality of reference spatially accurate wavelength resolved fluorescence spectroscopic images obtained from reference biological samples (e.g., cancerous human tissues). One or more of the reference biological samples may include fluorescence probe molecules (e.g., fluorescein isothiocyanate). In one embodiment, a single database may be used to store all types of spectra.

The reference SWIR data sets may be associated with a reference SWIR image and/or a corresponding reference non-SWIR image. In one such embodiment, the reference non-SWIR image may include at least one of: a brightfield image; a polarized light image; and a UV-induced autofluorescence image.

FIG. 2C depicts an exemplary setup to remotely perform spectroscopic analysis of test samples according to one embodiment of the present disclosure. Spectroscopic data from a test sample or a test sample may be collected at a data generation site 260 using a spectroscopy module 265. In one embodiment, the spectroscopy module may be functionally similar to the spectroscopy module 110 discussed hereinbefore with reference to FIGS. 2A-2B. The spectroscopic data collected at the data generation site 260 may be transferred to a data analysis site 270 via a communication network 272. In one embodiment, the communication network 272 may be any data communication network such as an Ethernet LAN (local area network) connecting all the data processing and computing units within a facility, e.g., a university research laboratory, or a corporate research center. In that case, the data generation site 260 and the data analysis site 270 may be physically located within the same facility, e.g., a university research laboratory or a corporate research center. In alternative embodiments, the communication network 272 may include, independently or in combination, any of the present or future wireline or wireless data communication networks such as, for example, the Internet, the PSTN (public switched telephone network), a cellular telephone network, a WAN (wide area network), a satellite-based communication link, a MAN (metropolitan area network), etc. In this case, the data generation site 260 and the data analysis site 270 may be physically located in different facilities. In some embodiments, the data generation site 260 and the data analysis site 270 that are linked by the communication network 272 may be owned or operated by different entities.

The data analysis site 270 may include a processing module 275 to process the spectroscopic data received from the data generation site 260. In one embodiment, the processing module 275 may be similar to the processing module 120 and may also include a number of different databases (not shown) storing different reference spectroscopic data sets (e.g., a first plurality of reference SWIR data sets for non-progressive cancer tissues, a second plurality of reference SWIR data sets for progressive cancer tissues, a third plurality of reference SWIR data sets for invasive ductal carcinoma samples and a fourth plurality of reference SWIR data sets for invasive lobular carcinoma samples, etc.). The processing module 275 may include a processor (similar to the processor 122 of the processing module 120 in FIG. 1) that is configured to execute program code or software to perform various spectral data processing tasks according to the teachings of the present disclosure. The machine-readable program code containing executable program instructions may be initially stored on a portable data storage medium, e.g., a floppy diskette 294, a compact disc or a DVD 295, a data cartridge tape (not shown), or any other suitable digital data storage medium. The processing module 275 may include appropriate disk drives to receive the portable data storage medium and may be configured to read the program code stored thereon, thereby facilitating execution of the program code by its processor. The program code, upon execution by the processor of the processing module 275, may cause the processor to perform a variety of data processing and display tasks including, for example, initiate transfer of spectral data set from the data generation site 260 to the data analysis site 270 via the communication network 272, compare the received spectral data set to various reference data sets stored in the databases of the processing module 275, classify or identify the test sample based on the comparison (e.g., whether the test sample has a progressive cancer or non-progressive cancer state or whether the test sample has invasive ductal carcinoma disease or invasive lobular carcinoma disease), transfer the classification or identification results to the data generation site 260 via the communication network 272, etc.

In one embodiment, the data analysis site 270 may include one or more computer terminals 286A-286C communicatively connected to the processing module 275 via corresponding data communication links 290A-290C, which can be serial, parallel, or wireless communication links, or a suitable combination thereof. Thus, users may utilize functionalities of the processing module 275 via their computer terminals 286A-286C, which may also be used to display spectroscopic data received from the data generation site 260 and the results of the spectroscopic data processing by the processing module 275, among other applications. It is evident that in a practical application, there may be many more computer terminals 286 than just three terminals shown in FIG. 3.

The computer terminals 286A-286C may be, e.g., a personal computer (PC), a graphics workstation, a multiprocessor computer system, a distributed network of computers, or a computer chip embedded as part of a machine or mechanism. Similarly, the data generation site 260 may include one or more of such computers (not shown) for viewing the results of the spectroscopic analysis received from the data analysis site 270. Each computer terminal, whether at the data generation site 260 or at data analysis site 270, may include requisite data storage capability in the form of one or more volatile and non-volatile memory modules. The memory modules may include RAM (random access memory), ROM (read only memory) and HDD (hard disk drive) storage.

It is noted that the arrangement depicted in FIG. 2C may be used to provide a commercial, network-based spectroscopic data processing service that may perform customer-requested processing of spectroscopic data in real time or near real time. For example, the processing module 275 at the data analysis site 270 may be configured to identify a test sample from the spectroscopic data remotely submitted to it over the communication network 272 (e.g., the Internet) from the spectroscopy module 265 automatically or through an operator at the data generation site 260. The client site (data generation site) 260 may be, for example, a government laboratory or a medical facility or pathological laboratory. The results of spectroscopic data analysis may be transmitted back to the client site 260 for review and further analysis. In one embodiment, the whole data submission, analysis, and reporting process can be automated.

It is further noted that the owner or operator of the data analysis site 270 may commercially offer a network-based spectroscopic data content analysis service, as illustrated by the arrangement in FIG. 2C, to various individuals, corporations, governmental entities, laboratories, or other facilities on a fixed-fee basis, on a per-operation basis or on any other payment plan mutually convenient to the service provider and the service recipient.

Processing module 120 may also include a test SWIR database associated with a test biological sample having an unknown metabolic state. In one such embodiment, the test SWIR data set may correspond to a plurality of SWIR spectra of the test biological sample. In another such embodiment, the test SWIR data set may correspond to a plurality of spatially accurate wavelength resolved SWIR images of the test biological sample. In another embodiment, each of the test SWIR data sets may be associated with least one of the following: a corresponding test SWIR image; and a corresponding test non-SWIR image. In one such embodiment, the test non-SWIR image may include at least one of the followings a brightfield image; a polarized light image; a Raman image; a fluorescence image; and a UV-induced autofluorescence image.

In one such embodiment, processing module 120 may also include a test SWIR database associated with a test breast sample having an unknown breast disease state. In one such embodiment, the test SWIR data set may correspond to a plurality of SWIR spectra of the test breast sample. In another such embodiment, the test SWIR data set may correspond to a plurality of spatially accurate wavelength resolved SWIR images of the test breast sample. In another embodiment each of the test SWIR data sets may be associated with least one of the following: a corresponding test SWIR image; and a corresponding test non-SWIR image. In one such embodiment, the test non-SWIR image may include at least one of the following: a brightfield image; a polarized light image; a Raman image; a fluorescence image; and a UV-induced autofluorescence image.

In one embodiment, the test SWIR spectra are generated using a test SWIR image to identify one or more regions of interest of the test biological sample or the test breast sample. In one such embodiment, the one or more regions of interest contain at least one of the following: an epithelium area, a stroma area, epithelial-stromal junction (ESJ) area, and/or nuclei area. A plurality of test SWIR spectra may be obtained from the one or more of regions of interest of the test biological sample or the test breast sample.

A diagnosis of a test sample as diseased or non-diseased or as a first disease state or a second disease state or a prediction of the metabolic state of a test sample may be made by comparing a test SWIR data set to reference SWIR data sets using a chemometric technique. In one such embodiment, a diagnosis of a test breast sample as having an invasive ductal carcinoma disease state or an invasive lobular carcinoma disease state is generated. The chemometric technique may include at least one of the following: principle component analysis, cosine correlation analysis, Euclidian distance analysis, multivariate curve resolution, band t. entropy method, mahalanobis distance, adaptive subspace detector, and combinations thereof.

In one embodiment, the chemometric technique may be spectral unmixing. The application of spectral unmixing to determine the identity of components of a mixture is described in U.S. Pat. No. 7,072,770, entitled “Method for Identifying Components of a Mixture via Spectral Analysis, issued on Jul. 4, 2006, which is incorporated herein by reference in it entirety. Spectral unmixing as described in the above referenced patent can be applied as follows: Spectral unmixing requires a library of spectra which include possible components of the test sample. The library can in principle be in the form of a single spectrum for each component, a set of spectra for each component, a single SWIR image for each component, a set of SWIR images for each component, or any of the above as recorded after a dimension reduction procedure such as Principle Component Analysis. In the methods discussed herein, the library used as the basis for application of spectral unmixing is the reference SWIR data sets.

With this as the library, a set of SWIR measurements made on a sample of unknown state, described herein as a test SWIR data set, is assessed using the methods of U.S. Pat. No. 7,072,770 to determine the most likely groups of components which are present in the sample. In this instance the components are actually disease states of interest and/or clinical outcome. The result is a set of disease state groups and/or clinical outcome groups with a ranking of which are most likely to be represented by the test data set.

Given a set of reference spectra, such as those described above, a piece or set of test data can be evaluated by a process called spectral mixture resolution. In this process, the test spectrum is approximated with a linear combination of reference spectra with a goal of minimizing the deviation of the approximation from the test spectrum. This process results in a set of relative weights for the reference spectra.

In one embodiment, the chemometric technique may be Principal Component Analysis. Using Principal Component Analysis results in a set of mathematical vectors defined based on established methods used in multivariate analysis. The vectors form an orthogonal basis, meaning that they are linearly independent vectors. The vectors are determined based on a set of input data by first choosing a vector which describes the most variance within the input data. This first “principal component” or PC is subtracted from each of the members of the input set. The input set after this subtraction is then evaluated in the same fashion (a vector describing the most variance in this set is determined and subtracted) to yield a second vector the second principal component. The process is iterated until either a chosen number of linearly independent vectors (P Cs) are determined, or a chosen amount of the variance within the input data is accounted for.

In one embodiment, the Principal Component Analysis may include a series of steps. A pre-determined vector space is selected that mathematically describes a plurality of reference SWIR data sets. Each reference SWIR data set may be associated with a known biological sample having an associated metabolic state. The test SWIR data set may be transformed into the pre-determined vector space, and then a distribution of transformed data may be analyzed in the pre-determined vector space to generate a diagnosis.

In another embodiment, the Principal Component Analysis may include a series of steps. A pre-determined vector space is selected that mathematically describes a first plurality of reference SWIR data sets associated with a known biological sample having an associated diseased state and a second plurality of reference SWIR data sets associated with a known biological sample having an associated non-diseased state. The test SWIR data set may be transformed into the pre-determined vector space, and then a distribution of transformed data may be analyzed in the predetermined vector space to generate a diagnosis.

In yet another embodiment, the Principal Component Analysis may include a series of steps. A pre-determined vector space is selected that mathematically describes a first plurality of reference SWIR data sets associated with a known biological sample having an associated progressive state and a second plurality of reference SWIR data sets associated with a known biological sample having an associated non-progressive state. The test SWIR data set may be transformed into the pre-determined vector space, and then a distribution of transformed data may be analyzed in the pre-determined vector space to generate a diagnosis.

In another embodiment, the Principal Component Analysis may include a series of steps. A pre-determined vector space is selected that mathematically describes a first plurality of reference SWIR data sets associated with a known biological sample having an associated first diseased state and a second plurality of reference SWIR data sets associated with a known biological sample having an associated second diseased state. The test SWIR data set may be transformed into the pre-determined vector space, and then a distribution of transformed data may be analyzed in the pre-determined vector space to generate a diagnosis.

In still yet another embodiment, the Principal Component Analysis may include a series of steps. A pre-determined vector space is selected that mathematically describes a first plurality of reference SWIR data sets associated with a known breast sample having an associated invasive ductal carcinoma disease state and a second plurality of reference SWIR data sets associated with a known breast sample having an associated invasive lobular carcinoma disease state. The test SWIR data set may be transformed into the pre-determined vector space, and then a distribution of transformed data may be analyzed in the pre-determined vector space.

The analysis of the distribution of the transformed data may be performed using a classification scheme. Some examples of the classification scheme may include: Mahalanobis distance, Adaptive subspace detector, Band target entropy method, Neural network, and support vector machine as an incomplete list of classification schemes known to those skilled in the art.

In one such embodiment, the classification scheme is Mahalanobis distance. The Mahalanobis distance is an established measure of the distance between two sets of points in a multidimensional space that takes into account both the distance between the centers of two groups, but also the spread around each centroid. A Mahalanobis distance model of the data is represented by plots of the distribution of the spectra in the principal component space. The Mahalanobis distance calculation is a general approach to calculating the distance between a single point and a group of points. It is useful because rather than taking the simple distance between the single point and the mean of the group of points, Mahalanobis distance takes into account the distribution of the points in space as part of the distance calculation. The Mahalanobis distance is calculated using the distances between the points in all dimensions of the principal component space.

In one such embodiment, once the test SWIR data is transformed into the space defined by the predetermined PC vector space, the test data is analyzed relative to the pre-determined vector space. This may be performed by calculating a Mahalanobis distance between the test Raman data set transformed into the pre-determined vector space and the SWIR data sets in the pre-determined vector space to generate a diagnosis.

The exemplary systems of FIGS. 1 and 2A-2C may be used to perform methods to predict the clinical outcome of patients or diagnose a disease state of patients. Processor 122 is configured to execute program instructions to carry out these methods.

The present disclosure also provides for a method. One embodiment of a method of the present disclosure is illustrated in FIG. 3. In such an embodiment, the method 300 may comprise obtaining a SWIR test data set representative of a test sample in step 310, wherein the test sample may comprise a breast tissue sample. In one embodiment, the SWIR test data set may be obtained by illuminating said test sample to thereby generate a first plurality of interacted photons. These interacted photons may be selected from the group consisting of: photons reflected by said test sample, photons absorbed by said test sample, photons emitted by said test sample, photons scattered by said test sample, and combinations thereof. The first plurality of interacted photons may be passed through a tunable filter. The tunable filter may be configured so as to separate said first plurality of interacted photons into a plurality of predetermined wavelength bands. In one embodiment, the tunable filter may be selected from the group consisting of: an acousto-optical tunable filter, a liquid crystal tunable filter, a multi-conjugate tunable filter, and combinations thereof. In another embodiment, the tunable filter may be selected from the group consisting of: a Fabry Perot angle tuned filter, a Lyot filter, an Evans split element liquid crystal tunable filter, a Sole liquid crystal tunable filter, a spectral diversity filter, a photonic crystal filter, a fixed wavelength Fabry Perot tunable filter, an air-tuned Fabry Perot tunable filter, a mechanically-tuned Fabry Perot tunable filter, and a liquid crystal Fabry Perot tunable filter

The first plurality of interacted photons may be detected to thereby generate said test SWIR data set. In one embodiment, the test SWIR data set may comprise at least one of: a SWIR spectrum representative of said test sample, a spatially accurate wavelength resolved SWIR image representative of said test sample, and combinations thereof. In one embodiment, the test SWIR data set may comprise a SWIR hyperspectral image representative of said test sample.

In step 320, a reference database may be provided, wherein the reference database may comprise a plurality of reference SWIR data sets, each reference SWIR data set corresponding to a known disease state. In step 330, the test SWIR data set may be compared to at least one of said reference SWIR data sets to thereby determine a disease state of said test sample. In one embodiment, this comparison may be achieved by applying a chemometric technique as described herein.

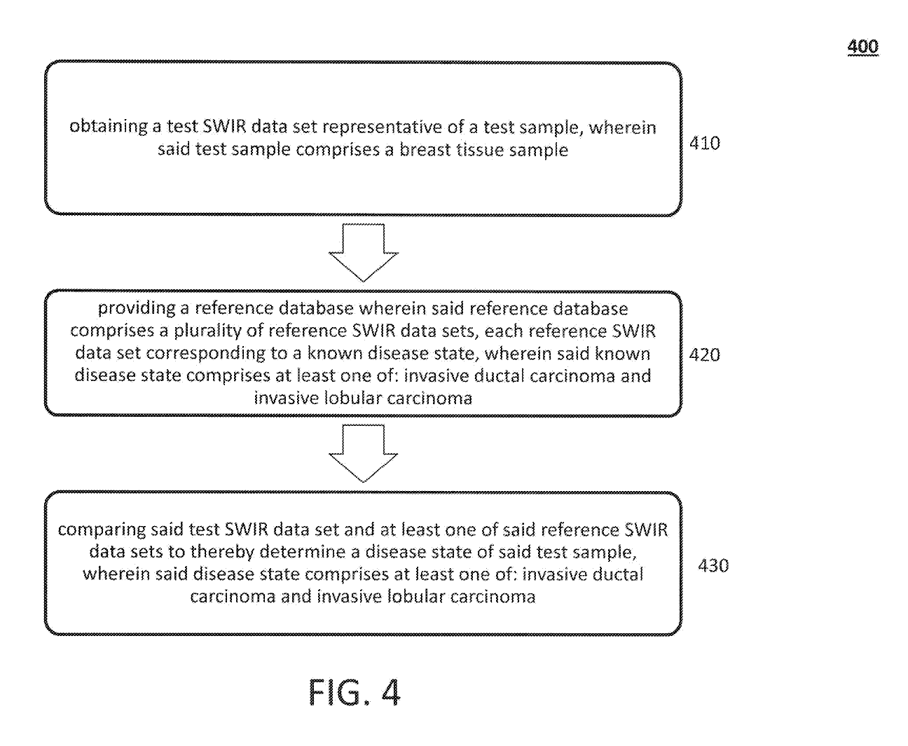

The present disclosure also provides for another embodiment, illustrated by FIG. 4. In such an embodiment, the method 400 may comprise obtaining a test SWIR data set representative of a test sample in step 410, wherein said test sample comprises a breast tissue sample. In step 420, a reference database may be provided wherein said reference database comprises a plurality of reference SWIR data sets, each reference SWIR data set corresponding to a know disease state. In one embodiment, as illustrated in FIG. 4, the disease state may comprise at least one of: invasive ductal carcinoma and invasive lobular carcinoma. In step 430 the test SWIR data set may be compared to at least one reference SWIR data set to thereby determine a disease state of said test sample, wherein said disease state comprises at least one of: invasive ductal carcinoma and invasive lobular carcinoma.

In one embodiment, the methods illustrated in FIG. 3 and FIG. 4 may further comprise steps for obtaining said SWIR data set. In one embodiment, this obtaining may comprise illuminating a test sample to thereby generate a first plurality of interacted photons. Interacted photons, as referred to herein, may comprise at least one of: photons reflected by a sample, photons absorbed by a sample, photons emitted by a sample, photons transmitted by a sample, photons scattered by a sample, and combinations thereof. These interacted photons may be passed through a tunable filter. In one embodiment, this tunable filter may be configured so as to separate said interacted photons into a plurality of predetermined wavelength bands. These interacted photons may then be detected using SWIR spectroscopic techniques to thereby generate said SWIR data set.

In one embodiment, the present disclosure provides for a method, wherein said method comprises fusing said test SWIR data set with at least one other test data set obtained using a different modality. In one embodiment, the method may comprise obtaining at least one of: a test Raman data set representative of said test sample, a test fluorescence data set representative of said sample, and combinations thereof.

In one embodiment, this fusion may be accomplished using Bayesian fusion. In one embodiment, this fusion may be accomplished using fusion technology available from ChemImage Corporation, Pittsburgh, Pa. This technology is more fully described in the following patent and published U.S. patent applications: US 2007/0192035, filed on Jun. 9, 2006, entitled “Forensic integrated Search Technology;” US 2009/0012723, filed on Aug. 22, 2008, entitled “Adaptive Method for Outlier Detection and Spectral Library Augmentation;” US 2008/0300826, filed on Jan. 22, 2008, entitled “Forensic Integrated Search Technology With Instrument Weight Factor Determination,” and U.S. Pat. No. 7,945,393, filed on Oct. 6, 2002, entitled “System and Method for Combined Raman, SWIR and LIBS Detection.” These patents and patent applications are hereby incorporated by reference in their entireties.

In one embodiment, the method may further comprise steps for generating at least one of said Raman and fluorescence data sets. These steps may comprise illuminating a test sample to thereby generate a first plurality of interacted photons. Interacted photons, as referred to herein, may comprise at least one of: photons reflected by a sample, photons absorbed by a sample, photons emitted by a sample, photons transmitted by a sample, photons scattered by a sample, and combinations thereof. These interacted photons may be passed through a tunable filter. In one embodiment, this tunable filter may be configured so as to separate said interacted photons into a plurality of predetermined wavelength bands. These interacted photons may then be detected using one or more spectroscopic techniques. These spectroscopic techniques may comprise at least one of Raman and fluorescence spectroscopic techniques.

At least one of said test Raman data set and said test fluorescence data set may be fused with said test SWIR data set to thereby generate a fused data set. This fused data set may be analyzed to thereby determine a disease state of said sample.

In one embodiment, said test Raman data set may comprise at least one of: a Raman spectrum representative of said test sample, a spatially accurate wavelength resolved Raman image representative of said test sample, and combinations thereof. In one embodiment, said test Raman data set may comprise a hyperspectral Raman image representative of said test sample.

In one embodiment, said test fluorescence data set may comprise at least one of: a fluorescence spectrum representative of said test sample, a spatially accurate wavelength resolved fluorescence image representative of said test sample, and combinations thereof. In one embodiment, said test fluorescence data set may comprise a hyperspectral fluorescence image representative of said test sample.

In one embodiment, this analyzing may be achieved by comparing said fused data set to one or more reference data sets in a reference database. This comparing may be achieved by applying at least one chemometric technique.

Although the disclosure is described using illustrative embodiments provided herein, it should be understood that the principles of the disclosure are not limited thereto and may include modification thereof and permutations thereof.

What is claimed is:

1. A method comprising:
obtaining a test SWIR data set representative of a test sample, wherein said test sample comprises a breast tissue sample;
providing a reference database wherein said reference database comprises a plurality of reference SWIR data sets, each reference SWIR data set corresponding to a known disease state;
comparing said test SWIR data set and at least one of said reference SWIR data sets to thereby determine a disease state of said test sample.

2. The method of claim 1 wherein said known disease state comprises at least one of: invasive ductal carcinoma and invasive lobular carcinoma.

3. The method of claim 1 wherein said obtaining of said test SWIR data set comprises:
illuminating said test sample to thereby generate a first plurality of interacted photons;
passing said first plurality of interacted photons through a tunable filter;
detecting said first plurality of interacted photons to thereby generate said test SWIR data set.

4. The method of claim 3 wherein said tunable filter is selected from the group consisting of: an acousto-optical tunable filter, a liquid crystal tunable filter, a multi-conjugate tunable filter, and combinations thereof.

5. The method of claim 3 wherein said first plurality of interacted photons are selected from the group consisting of: photons reflected by said test sample, photons absorbed by said test sample, photons emitted by said test sample, photon scattered by said test sample, and combinations thereof.

6. The method of claim 1 further comprising:
obtaining at least one of: a test Raman data set representative of said test sample, a test fluorescence data set representative of said test sample, and combinations thereof;
fusing at least one of said test Raman data set and said test fluorescence data set with said test SWIR data set to thereby generate a fused data set; and
analyzing said fused data set to thereby determine a disease state of said test sample.

7. The method of claim 6 wherein said analyzing comprises comparing said fused data set to at least one reference data set.

8. The method of claim 6 wherein said disease state comprises at least one of: invasive ductal carcinoma and invasive lobular carcinoma.

9. The method of claim 1 wherein said comparing is achieved using a chemometric technique.

10. The method of claim 7 wherein said comparing is achieved using a chemometric technique.

11. The method of claim 1 wherein at least one of said test SWIR data set and said reference SWIR data set comprises a SWIR hyperspectral image.

12. The method of claim 1 wherein at least one of said test. Raman data set and said reference Raman data set comprises a Raman hyperspectral image.

13. The method of claim 1 wherein at least one of said test fluorescence data set and said reference fluorescence data set comprises a fluorescence hyperspectral image.

14. A method comprising:
obtaining a test SWIR data set representative of a test sample, wherein said test sample comprises a breast tissue sample;
providing a reference database wherein said reference database comprises a plurality of reference SWIR data sets, each reference SWIR data set corresponding to a known disease state, wherein said known disease state comprises at least one of: invasive ductal carcinoma and invasive lobular carcinoma;
comparing said test SWIR data set and at least one of said reference SWIR data sets to thereby determine a disease state of said test sample, wherein said disease state comprises at least one of:
invasive ductal carcinoma and invasive lobular carcinoma.

15. The method of claim 14 wherein said obtaining comprises:
illuminating said test sample to thereby generate a first plurality of interacted photons;
passing said first plurality of interacted photons through a tunable filter;
detecting said first plurality of interacted photons to thereby generate said test SWIR data set.

16. The method of claim 15 wherein said first plurality of interacted photons are selected from the group consisting of: photons reflected by said test sample, photons absorbed by said test sample, photons emitted by said test sample, photons scattered by said test sample, and combinations thereof.

17. The method of claim 15 wherein said tunable filter is selected from the group consisting of: an acousto-optical tunable filter, a liquid crystal tunable filter, a multi-conjugate tunable filter, and combinations thereof.

18. The method of claim 14 wherein said comparing is achieved using a chemometric technique.

19. The method of claim 14 further comprising:
obtaining at least one of a test Raman data set representative of said test sample, a test fluorescence data set representative of said test sample, and combinations thereof;
fusing at least one of said test Raman data set and said test fluorescence data set with said test SWIR data set to thereby generate at fused data set;
analyzing said fused data set to thereby determine a disease state of said test sample.

20. The method of claim 19 wherein said analyzing comprises comparing said fused data set to at least one reference data set.

21. The method of claim 19 wherein said disease state comprises at least one of: invasive ductal carcinoma and invasive lobular carcinoma.

22. The method of claim 20 wherein said comparing is achieved using a chemometric technique.

23. The method of claim 14 wherein at least one of said test SWIR data set and said reference SWIR data set comprises a SWIR hyperspectral image.

24. The method of claim 14 wherein at least one of said test Raman data set and said reference Raman data set comprises a Raman hyperspectral image.

25. The method of claim 14 wherein at least one of said test fluorescence data set and said reference fluorescence data set comprises a fluorescence hyperspectral image.

26. A system comprising:
an illumination source for illuminating a test sample to thereby generate a first plurality of interacted photons;
a tunable filter configured so as to sequentially filter said first plurality of interacted photons into a plurality of predetermined wavelength bands;
a detector for detecting said first plurality of interacted photons and thereby generate a test SWIR data set representative of said test sample; and
a reference database comprising at least one reference SWIR data set, wherein said reference data set is associated with a known disease state.

27. The system of claim 26 further comprising a means for comparing said test SWIR data set with said at least one reference SWIR data set to thereby determine a disease state of said test sample.

28. The system of claim 26 wherein said known disease state comprises at least one of: invasive ductal carcinoma and invasive lobular carcinoma.

29. The system of claim 26 wherein said tunable filter is selected from the group consisting of: an acousto-optical tunable filter, a liquid crystal tunable filter, a multi-conjugate tunable filter, and combinations thereof.

30. The system of claim 26 further comprising a fiber array spectral translator device.

31. The system of claim 26 wherein at least one of said test SWIR data set and said reference SWIR data set comprises a SWIR hyperspectral image.

32. A storage medium containing machine readable program code, which, when executed by a processor, causes said processor to perform the following:
configure a system to obtain a test SWIR data set representative of a test sample, wherein said test sample comprises a breast tissue sample;
comparing said test SWIR data set and at least one reference SWIR data set to thereby determine a disease state of said test SWIR data set.

33. The storage medium of claim 32 wherein said disease state comprises at least one of: invasive ductal carcinoma and invasive lobular carcinoma.

34. The storage medium of claim 32 wherein at least one of said test SWIR data set and said reference SWIR data set comprises a SWIR hyperspectral image.

35. The storage medium of claim 32, which when executed by a processor, further causes said processor to perform the following:
configure an illumination source to illuminate a test sample to thereby generate at least one plurality of interacted photons representative of said test sample.

36. The storage medium of claim 32, which when executed by a processor, further causes said processor to perform the following:
configure said system to obtain at least one of a test Raman data set representative of said test sample, a test fluorescence data set representative of said test sample, and combinations thereof;
fuse at least one of said test Raman data set and said test fluorescence data set with said test SWIR data set to thereby generate at fused data set; and
analyze said fused data set to thereby determine a disease state of said test sample.

37. The storage medium of claim 36 wherein at least one of said test Raman data set and said reference Raman data set comprises a Raman hyperspectral image.

38. The storage medium of claim 36 wherein at least one of said test fluorescence data set and said reference fluorescence data set comprises a hyperspectral fluorescence image.

39. A system comprising:
a data generation site, wherein said data generation site comprises at least one spectroscopic device configured so as to generate at least one test data set representative of a test sample, wherein said test sample comprises a breast tissue sample;
a communication interface configured so as to operatively couple said data generation site and a data analysis site;
a reference data base at said data analysis site, wherein said reference data base comprises at least one reference data set, each reference data set corresponding to a known disease state;
a machine readable program code at said data analysis site, wherein said machine readable program code comprises executable program instructions; and
a processor at said data analysis site, wherein said processor is operatively coupled to said communication interface and said processor is configured so as to execute said machine readable program code so as to perform the following:
facilitate transfer of said test data set from said data generation site to said data analysis site via said communication interface,
compare said test data set to said at least one reference data set, wherein said comparing is achieved using a chemometric technique,
based on said comparison, diagnose a disease state of said test sample, and
transfer said diagnosis to said data generation site via said communication network.

40. The system of claim 39 wherein said spectroscopic device comprises a spectroscopic imaging device configured so as to generate at least one hyperspectral image representative of said test sample.

41. The system of claim 39 wherein said disease state comprises at least one of: invasive ductal carcinoma and invasive lobular carcinoma.

42. The system of claim 39 wherein said test data set comprises at least one of: a test SWIR data set, a test Raman data set, a test fluorescence data set, and combinations thereof.

43. The system of claim 41 wherein at least one test data set comprises a hyperspectral image.

44. The system of claim 41 wherein said at least one reference data set comprises at least one of: a reference SWIR data set, a reference Raman data set, a reference fluorescence data set, and combinations thereof.

45. The system of claim 39 wherein said at least one reference data set comprises a hyperspectral image.

46. The system of claim 39 wherein said spectroscopic device further comprises a tunable filter.

47. The system of claim 46 wherein said tunable filter is selected from the group consisting of: an acousto-optical tunable filter, a liquid crystal tunable filter, a multi-conjugate tunable filter, and combinations thereof.
